(19) United States
(12) Patent Application Publication
(10) Pub. No.: US 2010/0282577 A1
(43) Pub. Date: Nov. 11, 2010

(54) Link of a side chain for conveyor belts

(75) Inventors: Michele Rettore, San Giorgio Delle Pertiche (IT); Nicola Infanti, Tombolo (IT)

Correspondence Address: MODIANO & ASSOCIATI, Via Meravigli, 16, MILANO, 20123, IT

(73) Assignee: ALIT S.R.L.

(21) Appl. No.: 12/662,836

(22) Filed: May 6, 2010

(30) Foreign Application Priority Data
May 8, 2009 (IT) PD2009A000126

(51) Int. Cl. B65G 17/38

(52) U.S. Cl. 198/851

(57) ABSTRACT

A link of a side chain for conveyor belts, particularly for food, of the type comprising a substantially V-shaped body, the rear portion of which has, on each end part, a hole for the insertion of an end portion of a rod-like element; the outer rear end part has a lateral tab that is contoured to mesh with a wheel or belt provided with teeth of associated driving means. The lateral tab is formed so as to be crossed by the axis of the holes for the rod-like element.

The present invention relates to a link of a side chain for conveyor belts.

### BACKGROUND OF THE INVENTION

Links of side chain for conveyor belts, particularly for food, are currently known which are constituted by a substantially U-shaped body made of metal plate in which the front portion is shaped so as to fit between the two facing end parts of the rear portion of a facing identical link.

The front portion has two symmetrical and longitudinally extended slots for the passage and translational motion of an end portion of a rod-like element of the conveyor belt to which the chain link belongs.

The rear portion has, on each end part, a hole for the insertion of an end portion of an additional rod-like element.

The external rear end part has a lateral tab that is contoured for engagement with a wheel or belt provided with teeth of associated driving means.

In known types of link, this external lateral tab is constituted by a flap of metal plate which is folded and extends from the rear edge of the external end part and again to the rear beyond such rear edge.

An L-shaped tipping preventing element is then typically associated from the side of the link that is directed toward the conveyor belt and its horizontal portion is designed to slide below a guide of the conveyor belt.

When the lateral tab interacts with the tooth of the wheel or belt provided with teeth of the driving means, the thrust generated by the tooth of the wheel or belt provided with teeth produces a torque between the region of contact between the tooth and the tab and the region of contact of the tipping preventing shoulder with the corresponding guide, and such torque tends to impose a momentary rotation to the rod-like element of the belt that is jointly connected to the actuated link.

The sequential occurrence of these events determines the characteristic oscillation of the rod-like elements that compose the belt at the driving means, an oscillation which can lead to unwanted stress on the conveyed food product.

### SUMMARY OF THE INVENTION

The aim of the present invention is to provide a link of a side chain for conveyor belts that improves the smoothness of the transmission of motion from the driving means to the belt, thus improving the stability of the conveyed products and ensuring greater integrity thereof.

Within this aim, an object of the invention is to provide a link of a side chain for conveyor belts that is simple to provide, like known types of link.

Another object of the invention is to provide a link that is also capable of speeding up the assembly of the conveyor belt to which it belongs.

A further object of the invention is to provide a link that allows to provide conveyor belts that can be guided upward or downward with guiding toothed wheels that have a smaller diameter than the known art, with a significant improvement in the quality of the transfer of small products.

Another object of the invention is to provide a link that allows to form a chain that can be driven by means of toothed wheels laterally, from above and from below with known types of driving means.

Another object of the invention is to provide a link of a side chain for conveyor belts that is structurally simple, is easy to use, and can be manufactured with low costs with known systems and technologies.

This aim, as well as these and other objects that will become better apparent hereinafter, are achieved by a link of a side chain for conveyor belts, particularly for food, of the type comprising a substantially V-shaped body, with the front portion shaped so as to fit between the two facing end parts of the rear portion of an identical link arranged in front, said front portion having two longitudinally elongated symmetrical slots for the passage and translational motion of an end portion of a rod-like element of a conveyor belt, said rear portion having, on each of said end parts, a hole for the insertion of an end portion of an additional rod-like element, the outer rear end part having a lateral tab that is contoured to mesh with a wheel or belt provided with teeth of associated driving means, said link being characterized in that said lateral tab is formed, on said outer rear end part, so that it is crossed by the axis of the holes for a rod-like element.

### BRIEF DESCRIPTION OF THE DRAWINGS

Further characteristics and advantages of the invention will become better apparent from the following detailed description of six preferred but not exclusive embodiments of a link of a side chain for conveyor belts, particularly for food, according to the invention, illustrated by way of non-limiting example in the accompanying drawings, wherein:

FIG. 1 is a first perspective view of a link according to the invention in a first embodiment thereof;

FIG. 2 is a second perspective view of the link of FIG. 1;

FIG. 3 is a plan view of a conveyor belt provided by means of links according to the invention of the first embodiment;

FIG. 4 is a first perspective view of a link according to the invention in a second embodiment thereof;

FIG. 5 is a second perspective view of the link of FIG. 4;

FIG. 6 is a perspective view of a second embodiment of a conveyor belt provided by means of links of the second embodiment;

FIG. 7 is an exploded perspective view of a third embodiment of a conveyor belt provided by means of links of the second embodiment;

FIGS. 8 and 9 are views of a guiding element of a conveyor belt provided by means of links of the second embodiment of the invention;

FIG. 10 is a plan view of a conveyor belt provided by means of links of the second embodiment;

FIGS. 11 and 12 each show a perspective view of a link according to the invention in a third embodiment thereof;

FIGS. 13 and 14 each show a perspective view of a link according to the invention in a fourth embodiment thereof;

FIG. 15 is a perspective view of a fifth embodiment of the link according to the invention;

FIG. 16 is a perspective view of a sixth embodiment of the link according to the invention.

### DESCRIPTION OF THE PREFERRED EMBODIMENTS

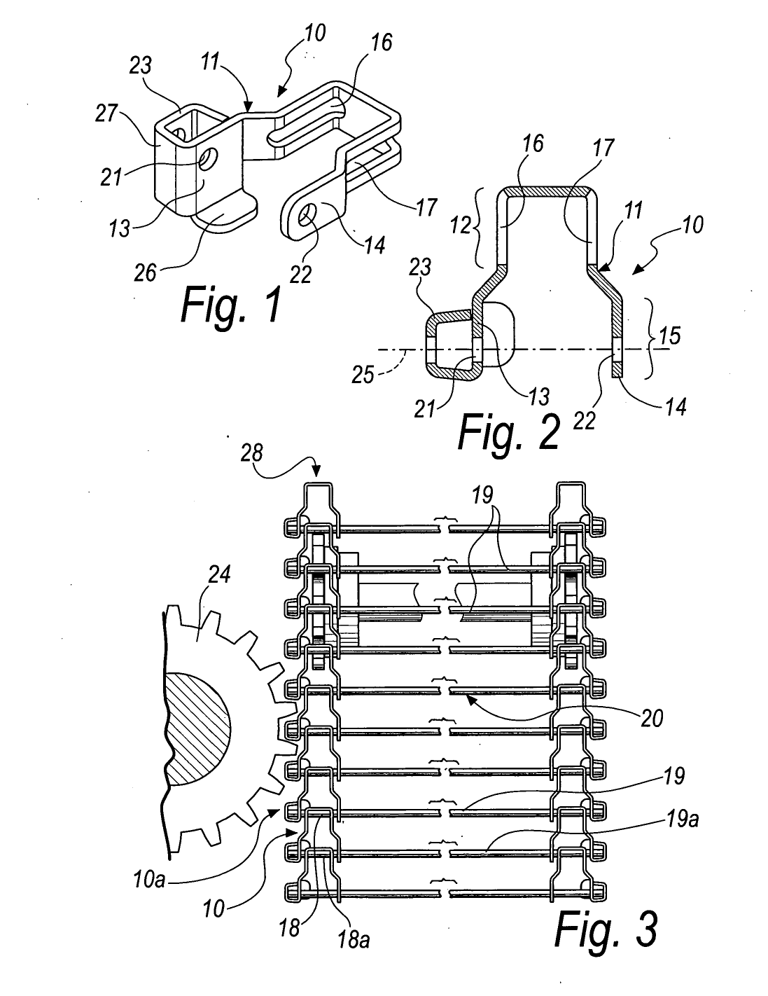

With reference to the figures, a link of a side chain for conveyor belts, particularly for food, is generally designated by the reference numeral 10 in its first embodiment, which is visible in FIGS. 1, 2 and 3.

The link 10 is of the type that comprises a substantially V-shaped body 11, with the front portion 12 shaped so as to fit between the two facing end parts 13 and 14 of the rear portion 15 of an identical link 10a arranged in front.

The front portion 12 has two longitudinally elongated symmetrical slots 16 and 17 for the passage and translational motion of an end portion 18 of a rod-like element 19 of a conveyor belt 20.

The rear portion 15 has, on each end part 13 and 14, a hole, respectively 21 and 22, for the insertion of an end portion 18a of an additional rod-like element 19a, as exemplified in FIG. 3.

The outer rear end part 13 has a lateral tab 23 that is contoured to mesh with a toothed wheel 24, but it might be a toothed belt, of associated driving means, of a per se known type, which are not shown for the sake of simplicity.

The lateral tab 23 is formed, on the outer rear end part 13, so that it is crossed by the axis of the holes 25 for the rod-like element 19a.

A tipping preventing shoulder 26 extends from the lower edge of the outer rear end part 13 and is designed to slide below a corresponding guide, which is to be understood as known, is not shown for the sake of simplicity and is associated with the conveyor belt 20.

In this first embodiment thereof, which is a non-limiting example of embodiment of the invention, the link 10 is made of metal plate.

The lateral tab 23 is provided by a flap 27 of metal plate, which extends from the outer end part 13 and is folded externally in a C-shaped configuration and so as to affect the axis 25 of the holes 21 and 22, as clearly shown in FIGS. 1 and 2.

The lateral tab 23, which differently from known links does not extend to the rear in a cantilever fashion, is stronger, allowing more stable and precise meshing of a chain 28, provided by means of a series of identical links 10, with the toothed wheel 24 of the driving means.

Further, the tipping preventing shoulder 26, which is incorporated in the link 10, allows to save a component to be assembled.

Moreover, such tipping preventing shoulder, being formed on the outer rear end part 13 at, and very close to, the lateral tab 23, is such that, when the lateral tab 23 interacts with a tooth of the toothed wheel 24 of the driving means, the thrust generated by the tooth of the toothed wheel, which might likewise also be a toothed belt, produces no torque between the region of contact between the tooth and the tab and the region of contact of the tipping preventing shoulder 26 with its guide, or a torque that is very modest with respect to what can be obtained with known links, with the corresponding guide.

This severe limitation or complete lack of the described torque produces a proportional strong limitation or elimination of the oscillations of the rod-like elements 19 and 19a of the belt 20, thus obtaining greater stability and integrity of the conveyed products during the passage of the belt at the driving means.

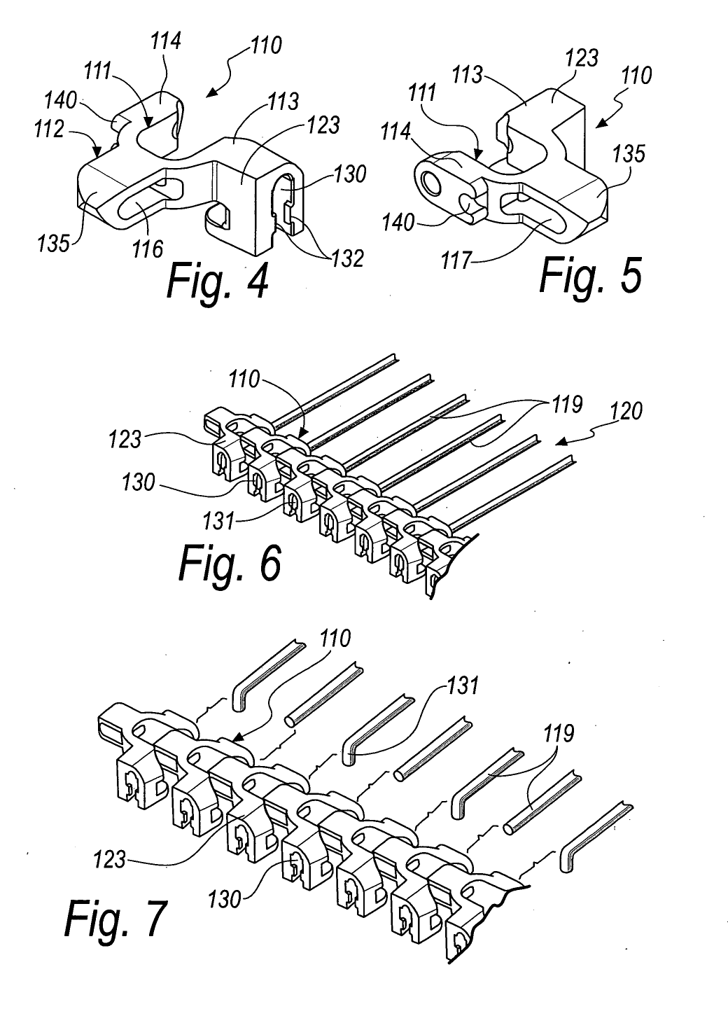

In its second embodiment, illustrated in particular in FIGS. 4 and 5 and designated therein by the reference numeral 110, the link 110 according to the invention is provided monolithically and made of plastics.

In the link 110, the lateral tab 123 extends toward the outside of the outer end part 113 and has a seat 130 for the rapid engagement of a complementarily shaped end 131 of a rod-like element 119 of the conveyor belt 120.

The seat 130 is open laterally onto the outside of the tab 123 and has protruding edges 132 for the snap engagement of the L-folded end 131 of a rod-like element 119.

The link 110 thus allows to provide a conveyor belt 120 with rod-like elements that have both ends 131 folded into an L-shaped configuration for engagement with the corresponding seats 130 on the lateral tabs 123, as shown in FIG. 6, or a similar conveyor belt whose rod-like elements 119 have a single L-folded end 131, as shown in FIG. 7, since it is sufficient in practice to fix just one of the two ends of the rod-like element in order to stabilize its position also with respect to the opposite associated link 110.

In such third embodiment of FIG. 7, the belt 120 is much faster and cheaper to provide.

Further, by adopting chains composed of the links 110, it is also much simpler to join two pieces of conveyor belt 120 and the operation for closing the belt 120, without resorting to welding or other mechanical operations with the addition of mechanical elements, is also much easier and faster.

In the second embodiment of the link 110, which is monolithic and made of plastics, the front portion 112 has two slots 116 and 117, which are the lateral ports of a single through opening that is formed transversely to the front portion 112.

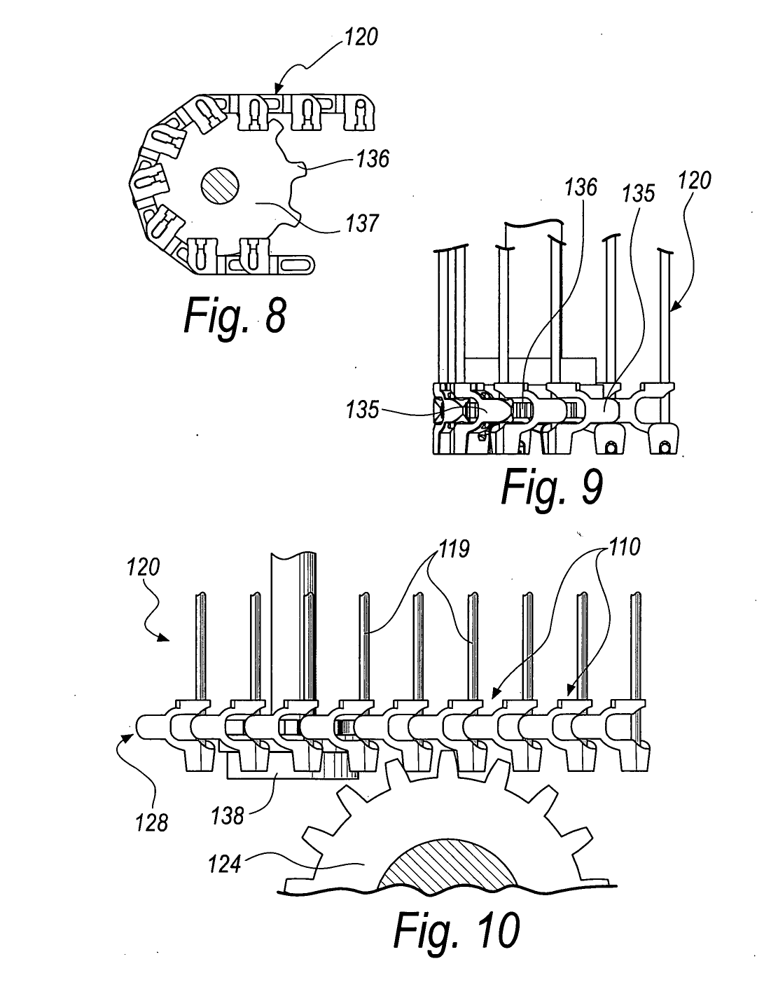

The tip 135 of the front portion 112 of the V-shaped body 111 has a profile shaped substantially like involutes of a circle, so as to better interact with the teeth 136 of a toothed wheel 137 for guiding the conveyor belt 120 upward, as shown in FIGS. 8 and 9, or downward.

The particular shaping of the V-shaped body 111 also allows to provide conveyor belts 120 in which the diameter of the guiding wheels is smaller than in similar belts with links of the known type, thus improving the transfer of small products from the belt 122 to another belt or to another subsequent platform.

The link 110, as clearly visible in FIG. 10, allows to provide chains 128 which can be driven easily either by means of a lateral toothed belt or wheel 124 or by means of a toothed belt or wheel 138 arranged above or below the chain 128.

The link 110, as shown in FIG. 5, has, on the inner face of the inner rear end part 114, a C-shaped seat 140 for the engagement of an end of a second rod-like element to be arranged laterally parallel to the first element 119 to provide a conveyor belt with a double number of rod-like elements.

The fitting of a second bar can be performed easily, conveniently and quickly even if the belt 120 is already assembled.

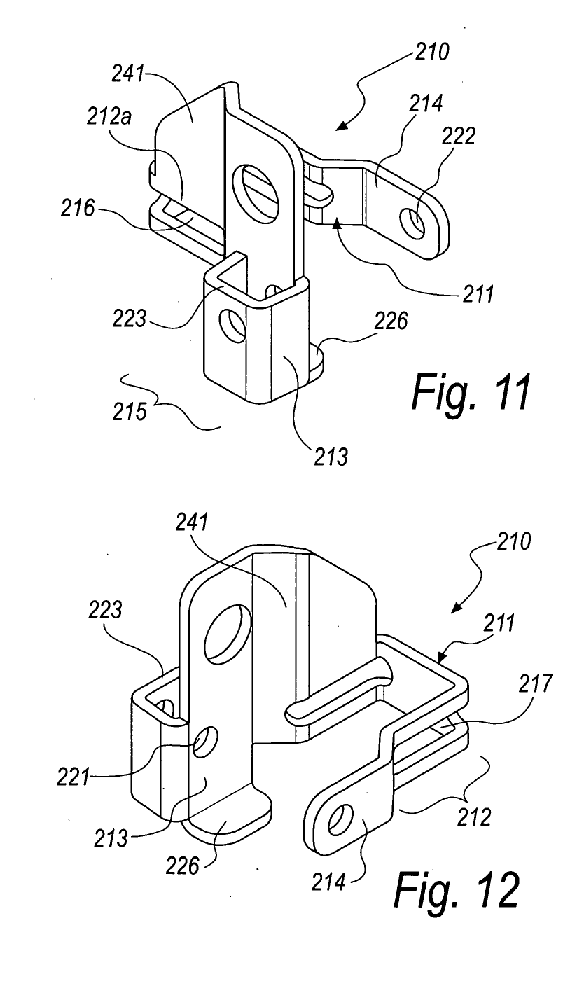

FIGS. 11 and 12 illustrate a link according to the invention in a third embodiment thereof, designated by the reference numeral 210.

The link 210, in a manner similar to what has been described above for the first embodiment, is made of metal plate and is of a type that comprises a substantially V-shaped body 211, in which the front portion 212 is shaped so as to fit between the two facing end parts 213 and 214 of the rear portion of a facing identical link.

The front portion 212 has two symmetrical slots 216 and 217, while the rear portion 215 has, on each one of the end parts 213 and 214, a hole, respectively 221 and 222, for the insertion of an end portion of an additional rod-like element.

The outer rear end part 213 has the lateral tab 223, which is shaped as described above so as to be crossed by the axis of the holes for the rod-like element, and the tipping preventing shoulder 226 extends from its lower edge and is designed to slide below a corresponding guide.

The link 210 also has a containment shoulder 241 for the products conveyed by the conveyor belt to which such link belongs.

The containment shoulder 241 extends upward from the rear end part 213 and from the corresponding side 212a of the front portion 212.

The containment shoulder 241 is obtained from the same sheet of metal plate from which the link 210 is provided and therefore is monolithic therewith.

The link 210 is thus shaped so that upon assembly of the conveyor belt one avoids installing the containment flaps of the known type, with a considerable reduction in the time and labor for the assembly of such conveyor belt.

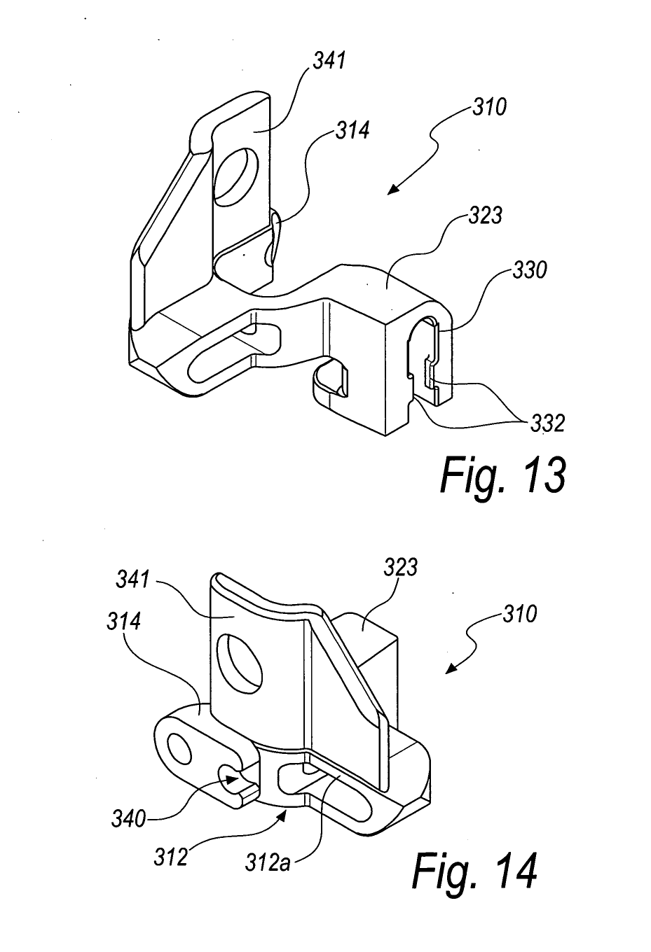

FIGS. 13 and 14 illustrate a link according to the invention in a fourth embodiment thereof, designated by the reference numeral 310.

The link 310 is provided monolithically and made of plastics.

The lateral tab 323 of the link 310 extends toward the outside of the outer end part 313 and has a seat 330 for the rapid engagement of a complementarily shaped end of a rod-like element of the conveyor belt.

The seat 330 is open laterally onto the outside of the tab 323 and has protruding edges 332 for the snap engagement of the L-folded end of a rod-like element.

The link 310 has, on the inner face of the inner rear end part 314, a C-shaped seat 340 for the engagement of an end of a second rod-like element to be arranged laterally and parallel to the first one, in order to provide a conveyor belt with a double number of rod-like elements.

The link 310 also has a containment shoulder 341 for the products conveyed by the conveyor belt to which such link belongs.

The containment shoulder 341 extends upward from the inner rear end part 214 and from the corresponding side 312a of the front portion 312.

The containment shoulder 341 is made of plastics and is provided monolithically with the link 310.

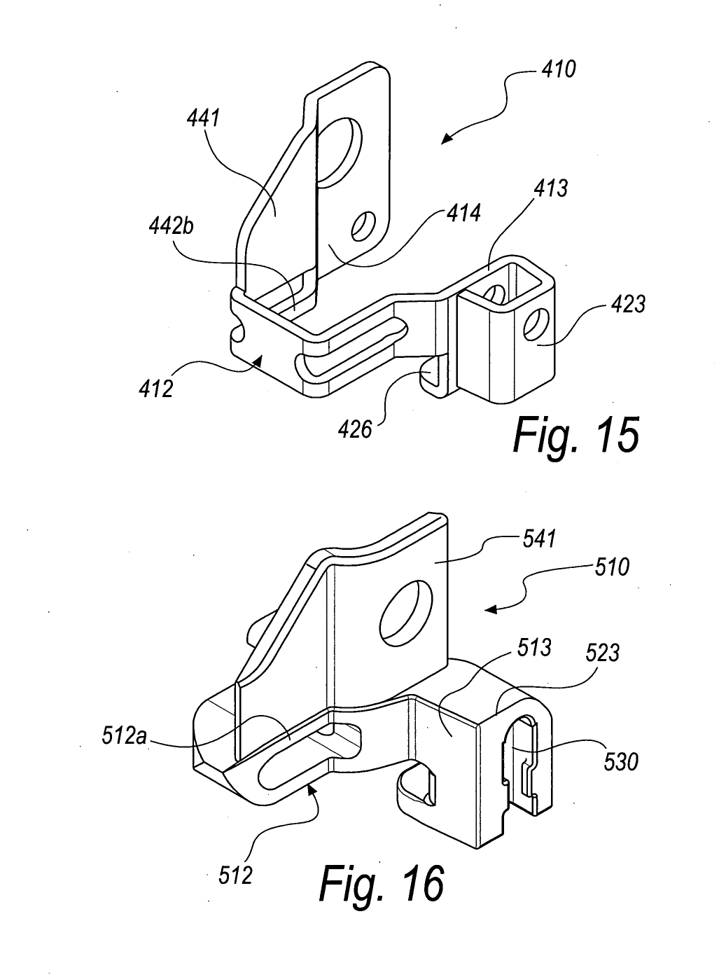

FIG. 15 is a view of a link according to the invention in a fifth embodiment thereof, designated by the reference numeral 410.

The link 410, in a manner similar to what has been described above for the first and third embodiments, is made of metal plate.

The outer rear end part 413 has the lateral tab 423, which is shaped as described above so as to be crossed by the axis of the holes for the rod-like element, and the tipping preventing shoulder 426 extends from its lower edge and is designed to slide below a corresponding guide.

The link 410 also has a containment shoulder 441 that extends upward from the inner rear end part 414 and from the corresponding inner side 412b of the front portion 412.

FIG. 16 illustrates a link according to the invention in a sixth embodiment thereof, designated by the reference numeral 510.

The link 510 is provided monolithically and is made of plastics.

The lateral tab 523 of the link 310 extends toward the outside of the outer end part 513 and has a seat 530 for the quick engagement of a complementarily shaped end of a rod-like element of the conveyor belt.

The link 510 also has a containment shoulder 541 for the products conveyed by the conveyor belt to which such link belongs.

Differently from the above described fourth embodiment of the link 310, the containment shoulder 541 extends upward from the outer rear end part 513 and from the corresponding side 512a of the front portion 512.

The containment shoulder 541 is made of plastics and is provided monolithically with the link 510.

In practice it has been found that the invention achieves the intended aim and objects.

In particular, the present invention provides a link for a side strain for conveyor belts that improves the smoothness of the transmission of motion from the driving means to the belt, thus improving stability and ensuring greater integrity of the conveyed products.

Moreover, the invention provides a link of a side chain for conveyor belts that is simple to provide, for example made of metallic plate, like links of the known type.

Moreover, the invention provides a link that is also capable of providing swifter assembly of the conveyor belt to which it belongs, for example in the embodiment made of plastics exemplified above, which is provided with a seat for rapid snap engagement of a contoured end of an associated rod-like element of the belt.

Moreover, the invention provides a link that allows to provide conveyor belts that can be guided upward or downward with guiding toothed wheels that have a smaller diameter than the known art, with a significant improvement in the quality of the transfer of small products.

The link according to the invention further allows to define a chain that can be driven by means of toothed wheels laterally, from above and from below with known types of driving means.

Further, with such a link it is possible to provide conveyor belts for drum-type spirals, even of a known type.

Moreover, the present invention provides a link of a side chain for conveyor belts that is structurally simple, easy to use, and can be manufactured at low costs with known systems and technologies.

The invention thus conceived is susceptible of numerous modifications and variations, all of which are within the scope of the appended claims; all the details may further be replaced with other technically equivalent elements.

In practice, the materials used, as well as the contingent shapes and dimensions, may be any according to requirements and to the state of the art.

The disclosures in Italian Patent Application No. PD2009A000126 from which this application claims priority are incorporated herein by reference.

What is claimed is:

1. A link of a side chain for conveyor belts, particularly for food, of the type comprising a substantially V-shaped body, with the front portion shaped so as to fit between the two facing end parts of the rear portion of an identical link arranged in front, said front portion having two longitudinally elongated symmetrical slots for the passage and translational motion of an end portion of a rod-like element of a conveyor belt, said rear portion having, on each of said end parts, a hole for the insertion of an end portion of an additional rod-like element, the outer rear end part having a lateral tab that is contoured to mesh with a wheel or belt provided with teeth of associated driving means, wherein said lateral tab is formed, on said outer rear end part, so that it is crossed by the axis of the holes for said rod-like element.

2. The link according to claim 1, wherein a tipping preventing shoulder extends from the lower edge of said outer rear end part and is designed to slide below a corresponding guide associated with said conveyor belt.

3. The link according to claim 1, wherein it is made of metal plate, said lateral tab being provided by a flap of metal plate that extends from said outer end part and is folded externally in a C-shaped configuration so as to affect the axis of said holes.

4. The link according to claim 1, wherein it is made monolithically of plastics.

5. The link according to claim 4, wherein said lateral tab extends toward the outside of said outer end part and has a seat for the rapid engagement of a complementarily shaped end of a rod-like element of the conveyor belt.

6. The link according to claim 5, wherein said seat is open laterally on the outside of said tab and has protruding edges for the snap engagement of the L-folded end of a rod-like element.

7. The link according to claim 1, wherein a tip of the front portion of the V-shaped body has a profile substantially formed by involutes of a circle.

8. The link according to claim 1, comprising, on the internal face of the inner rear end part, a C-shaped seat for the engagement of an end of a second rod-like element to be arranged laterally adjacent and parallel to the first rod-like element, to provide a conveyor belt with a double number of rod-like elements.

9. The link according to claim 1, comprising a containment shoulder for the products conveyed by the conveyor belt to which said link belongs, said shoulder being monolithic with said link.
